(19) United States
(12) Patent Application Publication
(10) Pub. No.: US 2004/0139849 A1
(43) Pub. Date: Jul. 22, 2004

(54) Vacuum brake booster

(76) Inventors: Rolf Fellinger, Dreikirchen (DE); Holger von Hayn, Bad Vilbel (DE); Jurgen Schonlau, Walluf (DE); Michael Vogt, Simmern (DE); Manfred Ruffer, Sulzbach (DE); Wolfgang Ritter, Oberursel (DE); Milian Klimes, Zornheim (DE); Torsten Queisser, Frankfurt/M (DE)

Correspondence Address: RATNERPRESTIA, P O BOX 980, VALLEY FORGE, PA, 19482-0980, US

(21) Appl. No.: 10/752,892

(22) Filed: Jan. 7, 2004

(30) Foreign Application Priority Data
Jan. 22, 2003 (DE) 10302279.1

(51) Int. Cl. F15B 9/10

(52) U.S. Cl. 91/376 R

(57) ABSTRACT

The present invention relates to a vacuum brake booster for motor vehicles, including a booster housing whose interior is subdivided by a movable wall into a vacuum chamber and a working chamber, a control valve that controls the pressure difference acting on the movable wall and is arranged in a control housing that carries the movable wall, said control valve being composed of two concentrically arranged sealing seats and an elastically deformable valve member, as well as including at least one filter in the air passage.

It is the essence of the invention that the control housing includes an adapter, which carries at least one filter.

### TECHNICAL FIELD

The present invention relates to a vacuum brake booster for motor vehicles, including a booster housing whose interior is subdivided by a movable wall into a vacuum chamber and a working chamber, a control valve that controls the pressure difference acting on the movable wall and is arranged in a control housing that carries the movable wall, said control valve being composed of two concentrically arranged sealing seats and an elastically deformable valve member, and including at least one filter in the air passage.

### BACKGROUND OF THE INVENTION

Vacuum brake boosters of this type are generally known in the art. DE 29 18 734 A1 discloses a vacuum brake booster, which includes in the air passage a hollow-cylindrical lining for noise insulation and filtering purposes. The filtering effect cannot be easily adapted to different conditions and, therefore, is considered as needing improvement.

### BRIEF SUMMARY OF THE INVENTION

An object of the present invention is to improve upon a vacuum brake booster in such a fashion that minimizing the suction noises and achieving a quicker response time is rendered possible by simple means.

This object is achieved by the present invention in that the control housing includes an adapter, which carries at least one filter. Said adapter allows arranging different filter constructions and filter shapes on the control housing, without the need to modify its construction.

According to a favorable improvement of the invention, several filters are arranged in the adapter and exhibit a different permeability. This provides the possibility of adapting the filter effect to the respective case of application.

The adapter preferably includes a collar for attaching a pleated bellows or a cap.

In another favorable embodiment of the invention, the adapter has a collar for abutment on an end face of the control housing, thereby defining the position of the adapter.

Preferably, the adapter has a cylindrical wall that extends partly over the end face of the control housing, said wall including radial openings which permit radial air aspiration and an improved response time of the vacuum brake booster.

As another provision of noise reduction upon the inflow of air, the adapter preferably includes an extension in diameter on the side remote from the control housing, whereby the air inflow is positively affected.

In a favorable improvement, the adapter includes at least one resilient leg, said leg being in resilient abutment on an inside surface of the control housing, whereby the adapter is retained in the control housing. Hence, no structural modification of the control housing is necessary to fasten the adapter in the control housing.

According to a favorable embodiment, the adapter includes several resilient legs that permit a higher degree of retaining force for attaching the adapter in the control housing.

The construction is simplified when the adapter has a guide for the valve member. The guide and the adapter are preferably designed integrally of any plastic material. The position is defined and the adapter fastened by the arrangement of the guide in the control housing.

For closing an axial opening of the control housing close to the pedal assembly, the adapter includes a cap attached to the collar. Said cap reduces the propagation of noises into the passenger compartment of the motor vehicle which are produced by operation of the vacuum brake booster.

Preferably, the adapter carries an annular filter, said filter being arranged on the radial openings. Also, said filter renders it possible to reduce noises when air is aspirated.

The adapter allows the aspiration of air through the axial opening close to the pedal assembly and/or by way of several radial openings.

### BRIEF DESCRIPTION OF THE DRAWINGS

FIG. 1 shows a first embodiment of a vacuum brake booster.

FIG. 2 shows a second embodiment of a vacuum brake booster.

FIG. 3 shows a third embodiment of a vacuum brake booster.

### DETAILED DESCRIPTION OF THE PREFERRED EMBODIMENTS

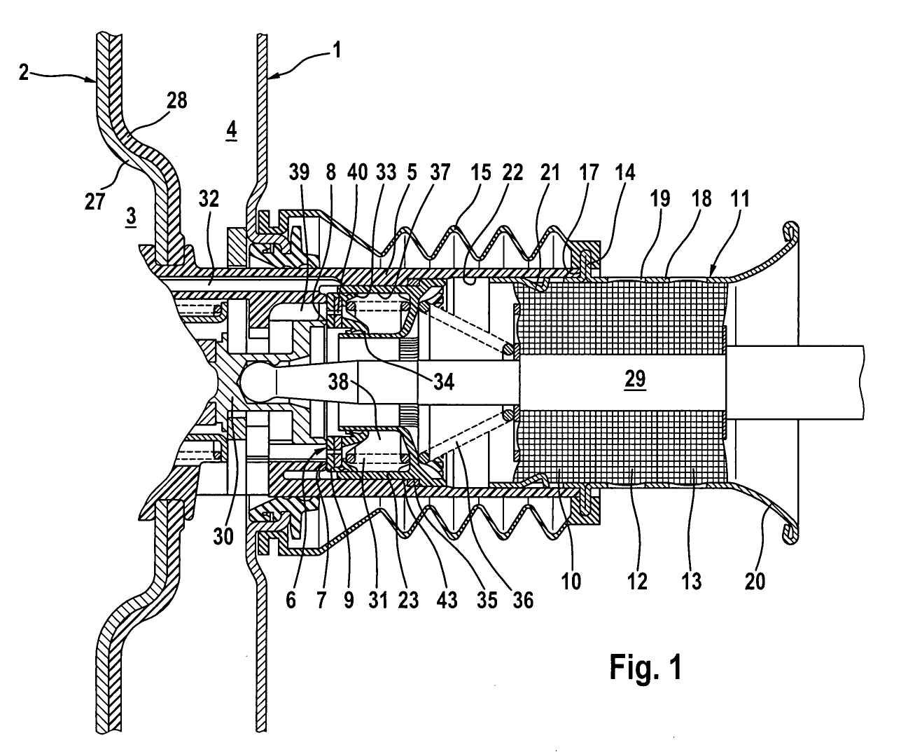

An only represented booster housing 1 of the vacuum brake booster shown in FIG. 1 is subdivided by an axially movable wall 2 into a working chamber 4 and a vacuum chamber 3. Said axially movable wall 2 is composed of a diaphragm plate 27, deepdrawn from sheet metal, and an abutting flexible diaphragm 28, which (not shown in detail) forms a rolling diaphragm as a seal between the outside periphery of the diaphragm plate 27 and the booster housing 1.

A control valve 6 operable by an actuating rod 29 is accommodated in a control housing 5 that is sealed in the booster housing 1 and carries the movable wall 2. Said control valve 6 is composed of a first sealing seat 7 designed on the control housing 5, a second sealing seat 8 designed on a valve piston 30 connected to actuating rod 29, and a valve member 9 that cooperates with both sealing seats 7,8, is movably arranged in a guide 23 and urged against the valve seats 7, 8 by means of a valve spring 31 supported on guide 23. The working chamber 4 is connectable to vacuum chamber 3 by way of a channel 32 extending laterally in control housing 5.

By way of a non-illustrated rubber-elastic reaction disc abutting frontally on control housing 5 and a non-illustrated push rod, the brake force is transmitted onto an actuating piston of a non-illustrated master cylinder of the brake system that is fitted to the vacuum-side end of the vacuum brake booster. The inlet force introduced at the actuating rod 29 is transmitted to the reaction disc by means of the valve piston. The components of the reaction force transmission mechanism are not shown completely because the function of the reaction force transmission mechanism is generally known.

Guide 23 that is sealed by a sealing element 35 in relation to the control housing 5 is used to support a piston rod return spring 36, on the one hand, and to support the valve spring 31, on the other hand. The position of guide 23 in the control housing 5 is defined by a step 43 of control housing S. Valve member 9 has an annular design and includes a radially outward first sealing lip 33 being in sealing abutment with an inside surface 37 of the guide 23 and a radially inward second sealing lip 34. Valve member 9 confines with guide 23 a pneumatic pressure compensating chamber 38. Passages 40 in the valve member 9 provide for the connection between the pressure compensating chamber 38 and an annular chamber 39 or working chamber 4.

To minimize aspiration noises, control housing 5 includes a sheet-metal adapter 11 with several resilient legs 21, said legs 21 being in resilient abutment on an inside surface 22 of control housing 5 for attachment of the adapter 11. Adapter 11 that includes a cylindrical wall 18 has a collar 14 used for abutment of the adapter 11 on an end face 17 of control housing 5, on the one hand, and for attachment of a pleated bellows 15, on the other hand. The cylindrical wall 18 of adapter 11 extends partly over the end face 17 and has radial openings 19.

As can be seen in FIG. 1, three filters 10, 12, and 13, which may be made of different materials and may have different permeabilities are arranged in adapter 11. This allows adapting the filter effect to the respective application.

On the side of the cylindrical wall 18 remote from the control housing 5, the adapter 11 includes an extension 20 in diameter, which serves for improving the aspiration of air and minimizing the aspiration noise.

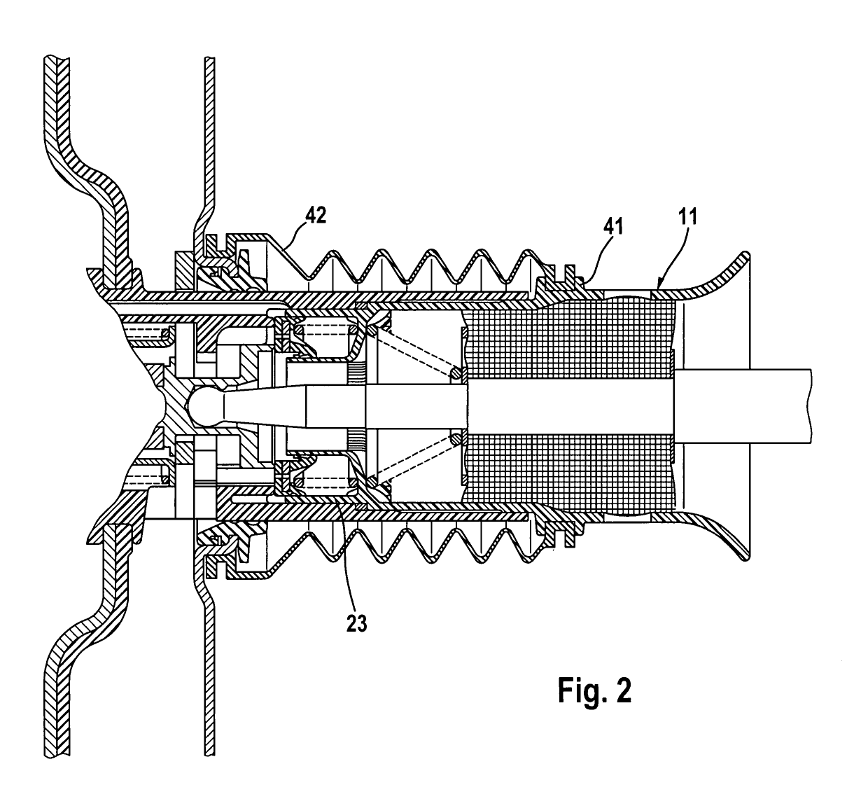

FIG. 2 shows a second embodiment of a vacuum brake booster. Adapter 11 and guide 23 in this embodiment are integrally made of plastics, comprising a collar 41 that is used to receive a pleated bellows 42. The position of adapter 11 is defined by the position of guide 23.

The other components of this embodiment correspond to the embodiment of FIG. 1.

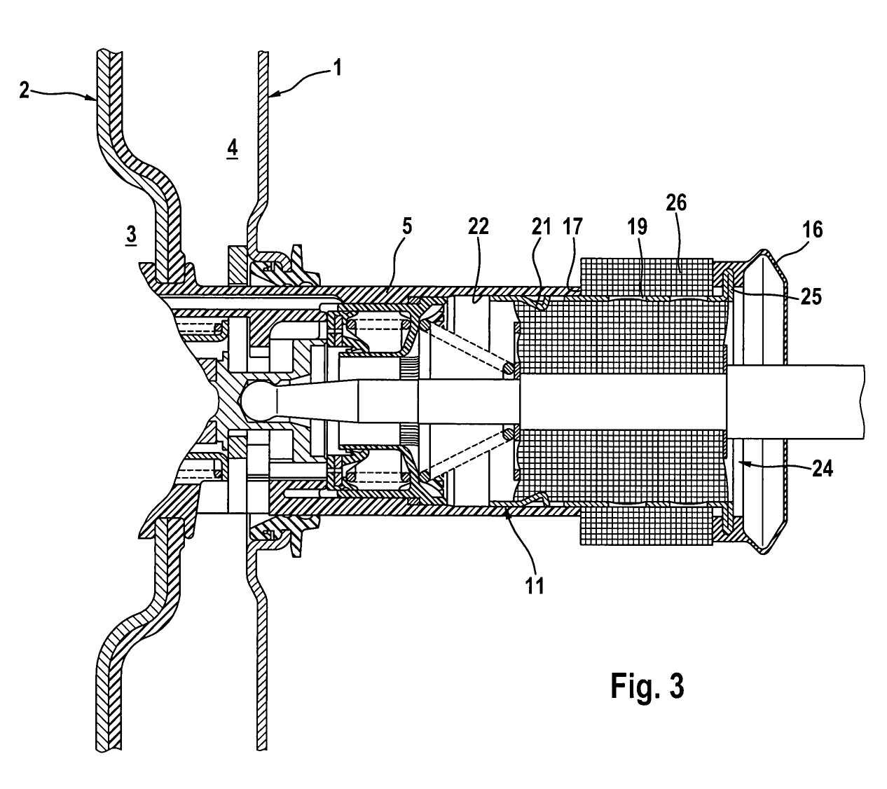

FIG. 3 shows a third embodiment of a vacuum brake booster. Adapter 11 is designed as a sheet-metal part and comprises legs 21 in resilient abutment with the inside surface 22 of control housing 5. To close an axial opening 24 close to the pedal assembly, the adapter 11 has a collar 25 used to attach a cap 16. This reduces the propagation of noises into the passenger compartment of the motor vehicle, the noises being produced by operation of the vacuum brake booster. Outside the control housing 5, adapter 11 carries an annular filter 26 that is used to minimize the aspiration noise.

All other components of this embodiment likewise correspond to the embodiment of FIG. 1.

List of Reference Numerals

1 booster housing

2 wall

3 vacuum chamber

4 working chamber

5 control housing

6 control valve

7 sealing seat

8 sealing seat

9 valve member

10 filter

11 adapter

12 filter

13 filter

14 collar

15 pleated bellows

16 cap

17 end face

18 wall

19 opening

20 extension

21 leg

22 inside surface

23 guide

24 opening

25 collar

26 filter

27 diaphragm plate

28 diaphragm

29 actuating rod

30 valve piston

31 valve spring

32 channel

33 sealing lip

34 sealing lip

35 sealing element

36 piston rod return spring

37 inside surface

38 pressure compensating chamber

39 annular chamber

40 passage

41 collar

42 pleated bellows

43 step

1. Vacuum brake booster for motor vehicles, including a booster housing (1) whose interior is subdivided by a movable wall (2) into a vacuum chamber (3) and a working chamber (4), a control valve (6) that controls the pressure difference acting on the movable wall (2) and is arranged in a control housing (5) that carries the movable wall (2), said control valve being composed of two concentrically arranged sealing seats (7, 8) and an elastically deformable valve member (9), and including at least one filter (10) in the air passage,
characterized in that the control housing (5) includes an adapter (11) that carries at least one filter (10).

2. Vacuum brake booster as claimed in claim 1,
characterized in that several filters (10, 12, 13) are arranged in the adapter (11), and the filters (10, 12, 13) exhibit different permeabilities.

3. Vacuum brake booster as claimed in claim 2,
characterized in that the adapter (11) includes a collar (14, 25) for attaching a pleated bellows (15) or a cap (16).

4. Vacuum brake booster as claimed in claim 3,
characterized in that the adapter has a collar (14) for abutment on an end face (17) of the control housing (5).

5. Vacuum brake booster as claimed in claim 3 or 4,
characterized in that the adapter (11) has a cylindrical wall (18) that extends partly over the end face (17) of the control housing (5), and the wall (18) includes radial openings (19).

6. Vacuum brake booster as claimed in claim 5,
characterized in that the adapter (11) includes an extension (20) in diameter on the side remote from the control housing (5).

7. Vacuum brake booster as claimed in any one of claims 3 to 6,
characterized in that the adapter (11) includes at least one resilient leg (21), and in that leg (21) is in resilient abutment on the inside surface (22) of the control housing (5).

8. Vacuum brake booster as claimed in claim 7,
characterized in that the adapter (11) includes several resilient legs (21).

9. Vacuum brake booster as claimed in any one of claims 3 to 6,
characterized in that the adapter (11) includes a guide (23) for the valve member (9), and the guide (23) and the adapter (11) are integrally designed of plastic material.

10. Vacuum brake booster as claimed in any one of claims 3 to 9,
characterized in that the adapter (11) includes cap (16) for closing an axial opening (24) of the control housing (5) close to the pedal assembly, said cap (16) being attached to the collar (25).

11. Vacuum brake booster as claimed in claim 10,
characterized in that the adapter (11) carries an annular filter (26), and in that filter (26) is arranged on the radial openings (19).

12. Vacuum brake booster as claimed in any one of claims 1 to 11,
characterized in that the adapter (11) allows the aspiration of air through the axial opening (24) close to the pedal assembly and/or through several radial openings (19) of the adapter (11).
